(19) United States
(12) Patent Application Publication
(10) Pub. No.: US 2021/0172211 A1
(43) Pub. Date: Jun. 10, 2021

(54) MOTOR VEHICLE LOCK ARRANGEMENT

(71) Applicant: Brose Schließsysteme GmbH & Co. Kommanditgesellschaft, Wuppertal, Wuppertal (DE)

(72) Inventor: David ROSALES, Rochester Hills, MI (US)

(73) Assignee: Brose Schließsysteme GmbH & Co. Kommanditgesellschaft, Wuppertal, Wuppertal (DE)

(21) Appl. No.: 16/708,714

(22) Filed: Dec. 10, 2019

(51) Int. Cl. E05B 81/16; E05B 81/14; E05B 77/06

(52) U.S. Cl. CPC E05B 81/16; E05B 81/14; B62D 33/037; E05Y 2900/546; E05B 77/06

(57) ABSTRACT

A motor vehicle lock including a catch configured to engage a lock striker, the catch is pivotable around a geometrical catch axis, and a pawl having a pawl arm configured to engage the catch, which pawl arm is pivotable around a geometrical pawl axis. The motor vehicle lock may be moved to closed state, in which the catch is in a closed position and in direct holding engagement with the lock striker and the pawl arm is in an associated closed position, where the pawl arm is in direct holding engagement with the catch blocking the catch in its closed position. When the pawl arm is in an open position releasing the catch, the motor vehicle lock can be brought into an open state, in which the catch is in an open position and releases the lock striker.

### TECHNICAL FIELD

The present disclosure relates to a motor vehicle lock arrangement for a hatch leaf of a vehicle.

### BACKGROUND

Motor vehicles may include hatch leaf that may include a motor vehicle lock arrangement. The term “hatch leaf” may refer to any kind of door of a motor vehicle, such as side doors or rear doors, tailgates, lift gates, trunk lids or engine hoods. Hatch leaf may also include a rear hatch leaf of a pickup truck.

In order to provide a holding function for the hatch leaf in its closed position, the motor vehicle lock may include a catch for the interaction with a lock striker and a pawl for holding the catch in its primary closed position. In a primary closed position the catch is in holding engagement with the lock striker, which leads to the hatch leaf to be held in its closed position.

### SUMMARY

According to one or more embodiments, a motor vehicle lock arrangement is provided. The motor vehicle lock arrangement may include may include a motor vehicle lock, which may include a catch for the interaction with a lock striker, which catch is pivotable about a geometrical catch axis, and a pawl having a pawl arm for the interaction with the catch, which pawl arm is pivotable about a geometrical pawl axis different from the geometrical catch axis. As an example, the catch and the pawl arm are pivotable in a common plane. The motor vehicle lock can be brought into at least one closed state, such as a primary closed state and a secondary closed state, in which the catch is in a respective closed position. In the primary closed position or secondary closed position, the catch is in direct holding engagement with the lock striker. In that respective closed state the pawl arm of the pawl is in an associated closed position, in which the pawl arm is in direct holding engagement with the catch blocking the catch in its closed position.

The primary closed state of the motor vehicle lock is the state, in which the catch is in direct holding engagement with the lock striker and the hatch leaf is fully closed. The secondary closed state of the motor vehicle lock is a state, in which the catch is also in direct holding engagement with the lock striker, but not yet pivoted further into its primary closed position. In the secondary closed state the hatch leaf is not yet fully closed.

When the pawl arm is in an open position, which is the position, in which the pawl arm releases the catch, the motor vehicle lock can be brought into an open state, in which the catch is in an open position and releases the lock striker. In the open state of the motor vehicle lock the hatch leaf can be opened.

According to one or more embodiments, a new way of interaction between the catch on the one hand and the pawl arm on the other hand to provide a forced-opening mechanism. Generally, it has been found, that for opening the motor vehicle lock and such as for a breakaway of the catch in the direction of its open position, the pawl arm does not necessarily have to interact directly with the catch. Instead, a lever-mechanism is provided, that may be formed separately from the catch and the pawl arm. The pawl arm can interact with the lever-mechanism and the lever-mechanism in turn can interact with the catch. With such a construction, the catch can always be forcedly moved over a sufficiently large distance towards its open position in case of a jamming due to high contamination, riveting or tolerance issues or ice building. Such a lever-mechanism also enables a breakaway of the pawl by the catch in the case, the pawl is unintentionally blocked in its open position due to one of the above conditions. Accordingly, the lever-mechanism may also provide a forced-closing mechanism for the pawl.

In detail, it is proposed that the motor vehicle lock arrangement may include a lever-mechanism which is designed separately from the catch and the pawl arm, and that, during a closing sequence for establishing a holding engagement of the catch with the lock striker and/or during an opening sequence for releasing the lock striker from the catch, the lever-mechanism, in a motion-coupled state with the catch, enables movement transmission between the lever-mechanism and the catch and, in a motion-coupled state with the pawl arm, enables movement transmission between the lever-mechanism and the pawl arm.

As will be described later in detail, depending on the design of the motor vehicle lock arrangement, the lever-mechanism can be actuated via the catch, namely during the closing sequence, and/or the lever-mechanism can be actuated via the pawl arm, namely during the opening sequence. According to another embodiment, additionally or alternatively, the lever-mechanism can be actuated via an additional associated drive component, such as during the closing sequence and/or during the opening sequence. Such an additional associated drive component is a drive component, which is part of a lever-mechanism drive train, as will be explained later, which drive train is configured to actuate the lever-mechanism. The catch and the pawl are not part of the lever-mechanism drive train. The drive component is designed separately from the catch and the pawl and interacts with the lever-mechanism separately from the catch and the pawl.

Here and in the following “actuating the lever-mechanism” means operating the lever-mechanism such that it transmits a force into the pawl arm or catch, respectively, such that the pawl arm or catch is pivoted about its respective geometrical axis.

104.1.11 One operating condition is a support operating condition of the motor vehicle lock. The motor vehicle lock is in a support operating condition when the catch or pawl arm is unintentionally blocked and cannot pivot, such as by spring force, as is normally the case. The motor vehicle lock is operated in the support operating condition for example in case of high contamination, riveting or tolerance issues or ice building. Otherwise, when the catch or pawl arm is not unintentionally blocked and can freely move, the motor vehicle lock is in its normal operating condition.

When the pawl arm is in the pawl-arm-open position, the lever-mechanism may be coupled to the pawl arm to transmit movement from the lever-mechanism to the pawl arm. During at least a portion of the closing sequence, the lever-mechanism and the pawl arm may be coupled to one another and each move in a first direction as the pawl arm moves from the pawl-arm-open position to a pawl-arm-closed position.

When the lever-mechanism is coupled to the catch to move the catch, the catch may be in a catch-primary-closed position or a catch-secondary-closed position or a position between the catch-primary closed position and the catch-open position.

According to one or more embodiments, a pawl arm drive train may be provided to pivot the pawl arm. As an example, the pawl arm drive train is configured to pivot the pawl arm, such as solely, from its closed position into its open position. The pawl arm drive train may comprise an electric motor or may be actuated manually, e.g. by manually actuating a hatch leaf handle.

A lever-mechanism drive train may be provided and configured to actuate the lever-mechanism. As an example, the lever-mechanism drive train is configured to actuate the lever-mechanism.

The lever-mechanism may include one or more levers.

### BRIEF DESCRIPTION OF THE DRAWINGS

In the following, the invention will be described with reference to exemplary embodiments illustrated in the drawings. In the drawings show

FIG. 1 a schematic view of a motor vehicle comprising a proposed motor vehicle lock arrangement with a motor vehicle lock,

FIG. 2 a part of a closing sequence of the motor vehicle lock according to FIG. 1 in its normal operating condition,

FIG. 3 a part of a closing sequence of the motor vehicle lock according to FIG. 1 in its support operating condition,

FIG. 4 a part of an opening sequence of the motor vehicle lock according to FIG. 1 in its support operating condition,

FIG. 5 in another embodiment a first part of a closing sequence of the motor vehicle lock according to FIG. 1 in its support operating condition,

FIG. 6 a second part of the closing sequence of the motor vehicle lock according to the embodiment shown in FIG. 5,

FIG. 7 in another embodiment a closing sequence of the motor vehicle lock according to FIG. 1 in its support operating condition and

FIG. 8 a schematic view of a drive unit with a switching logic of the motor vehicle lock according to FIG. 1.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A known motor vehicle lock arrangement (EP 1 739 258 A1), shows a motor vehicle lock arrangement comprising a motor vehicle lock with a spring-loaded catch and a spring-loaded pawl, wherein in the primary closed state of the motor vehicle lock the pawl arm of the pawl is in direct holding engagement with the catch blocking the catch in its closed position. To ensure safe opening of the motor vehicle lock, a forced-opening mechanism is provided for the catch. The forced-opening mechanism is formed by a section of the pawl, which, when the pawl is moved by an electric motor from its closed position to its open position, interacts with the catch such that the pawl takes the catch a small distance forcedly in direction of its open position with it.

An advantage of the known motor vehicle lock arrangement is that an initial blockage, e.g. caused by snow or ice, is overcome. The basic idea is that after an initial “breakaway” of the catch from the primary closing position, further opening of the motor vehicle lock and hatch leaf is easily possible. However, under certain conditions, e.g. in case of high contamination, riveting or tolerance issues etc., the small distance over which the pawl moves the catch may not be sufficient to ensure a breakaway and further spring driven movement of the catch towards its open position. Moreover, under conditions as mentioned before, also the pawl may be unintentionally blocked after being moved into its open position. In this case, the spring force may not be high enough to drive the pawl back to its closed position.

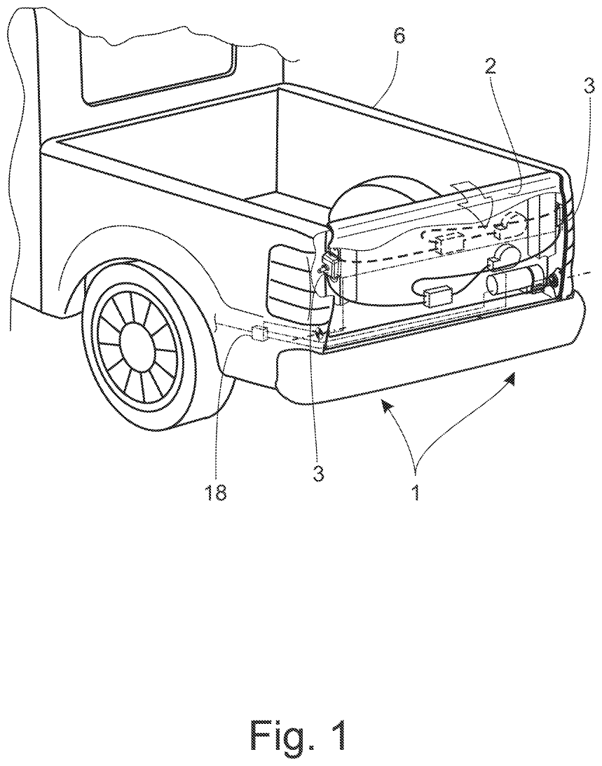

The motor vehicle shown in FIG. 1 may include a motor vehicle lock arrangement 1 for a hatch leaf 2. Regarding the broad understanding of the expression “hatch leaf”, reference is made to the introductory part of the specification.

The hatch leaf 2 may be pivotable about a hatch axis, which is aligned basically horizontally. It is also conceivable, that the hatch axis is aligned vertically.

The proposed motor vehicle lock arrangement 1 may include a motor vehicle lock 3. Just as a matter of completeness, it may be pointed out that the hatch leaf 2 is assigned not only one motor vehicle lock 3, but here two motor vehicle locks 3, that are arranged on opposite sides of the hatch leaf 2. In the following, only the motor vehicle lock 3 on the left side of the hatch leaf 2 is described. All explanations given to this motor vehicle lock 3 are fully applicable to the motor vehicle lock located on the opposite side of the hatch leaf 2.

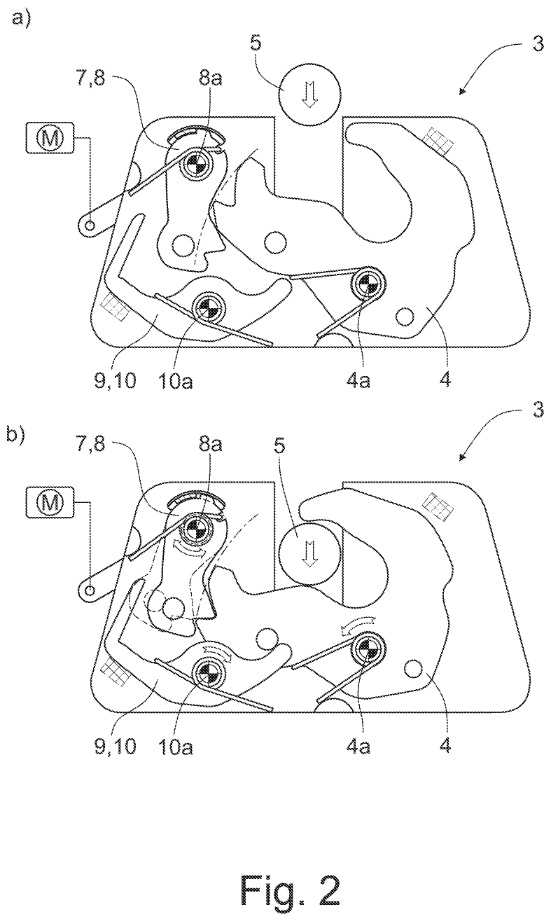

FIG. 2a) shows that the motor vehicle lock 3 may include a catch 4 for the interaction with a lock striker 5. The lock striker 5 may be located at the motor vehicle body 6. It is also possible, that the lock striker 5 is positioned at the hatch leaf 2, such that the motor vehicle lock 3 is then positioned at the motor vehicle body 6.

The catch 4 is pivotable about a geometrical catch axis 4a. The motor vehicle lock 3 further may include a pawl 7 having a pawl arm 8, which pawl arm 8 is pivotable about a geometrical pawl axis 8a. The geometrical catch axis 4a is different from the geometrical pawl axis 8a, such as distant from and parallel to the geometrical pawl axis 8a.

The motor vehicle lock 3 can be brought into at least one closed state, in which the catch 4 is in a closed position and in direct holding engagement with the lock striker 5 and in which the pawl arm 8 is in an associated closed position, in which the pawl arm 8 is in direct holding engagement with the catch 4 blocking the catch 4 in its respective closed position.

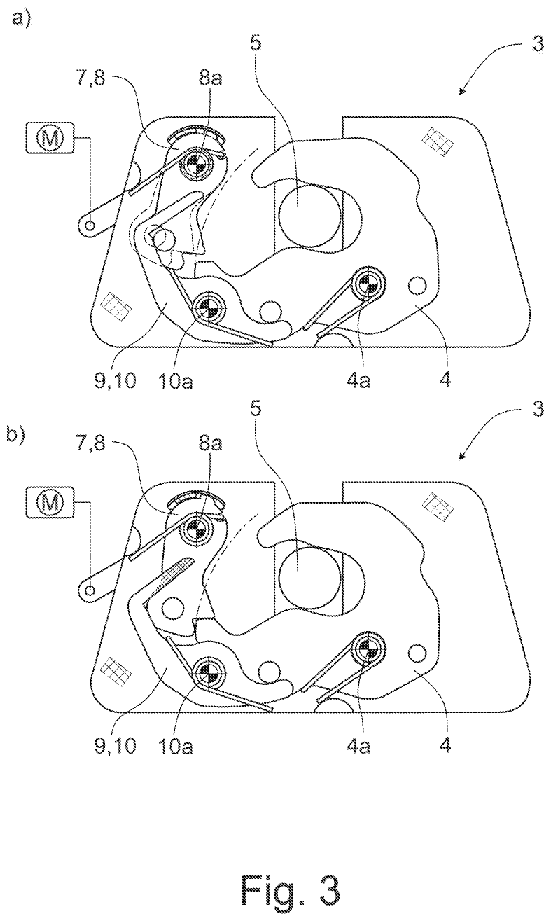

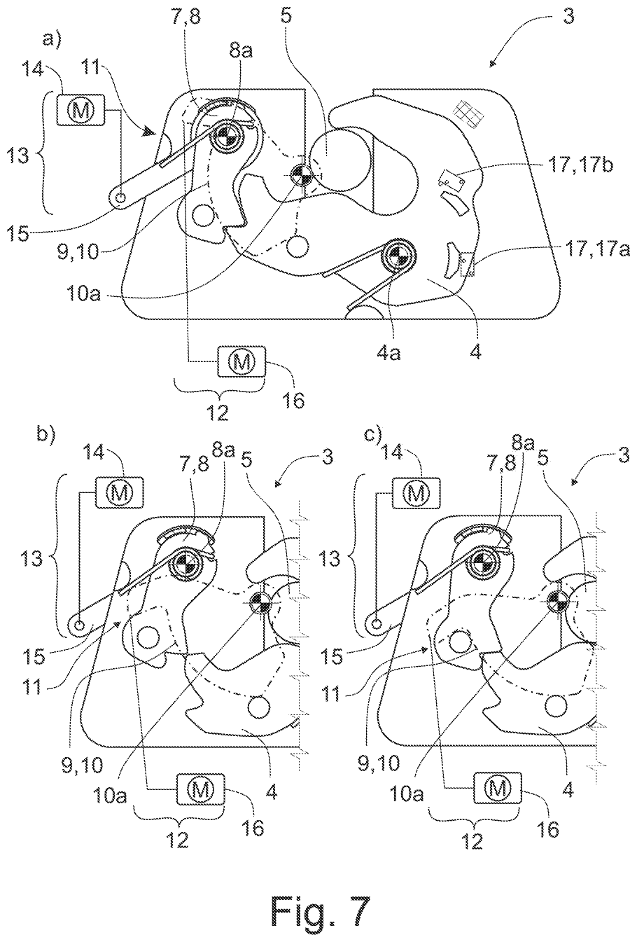

FIG. 2a) shows in an exemplary embodiment the open state of the motor vehicle lock 3 with the catch 4 being in its open position. FIG. 2b) shows the secondary closed state of the motor vehicle lock 3 with the catch 4 in its secondary closed position and with the pawl arm 8 in its associated closed position. The open position of the pawl arm 8 is shown with dashed lines. FIG. 3b) shows the primary closed state of the motor vehicle lock 3 with the catch 4 being in its primary closed position and with the pawl arm 8 being in its associated closed position. Here, the closed position of the pawl arm 8 in the primary closed state of the vehicle lock 3 is basically identical with the closed position of the pawl arm 8 in the secondary closed state of the motor vehicle lock 3. Moreover, FIG. 3a) shows the catch 4 in an overtravel position, which, seen from the open position of the catch 4, is beyond the primary closed position of the catch 4. In this exemplary embodiment such an overtravel position facilitates the movement of the pawl arm 8 from its open position into its closed position. However, as can be seen in the exemplary embodiment of FIG. 7, moving the catch 4 in an overtravel position is not necessarily required for allowing the movement of the pawl arm 8 from its open position into its closed position.

Moreover, when the pawl arm 8 is in its open position, the catch 4 is released and the motor vehicle lock 3 can be brought into its open state, in which the catch is in its open position and releases the lock striker 5.

It is essential for the invention that the motor vehicle lock arrangement 1 may include a lever-mechanism 9 which is designed separately from the catch 4 and the pawl arm 8, and that, during a closing sequence for establishing a holding engagement of the catch 4 with the lock striker 5 and/or during an opening sequence for releasing the lock striker 5 from the catch 4, the lever-mechanism 9, in a motion-coupled state with the catch 4, enables movement transmission between the lever-mechanism 9 and the catch 4 and, in a motion-coupled state with the pawl arm 8, enables movement transmission between the lever-mechanism 9 and the pawl arm 8.

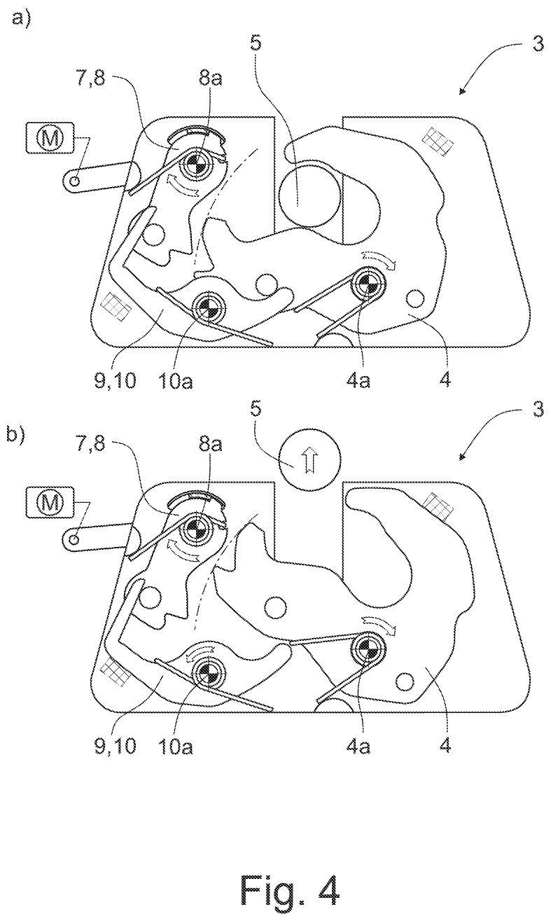

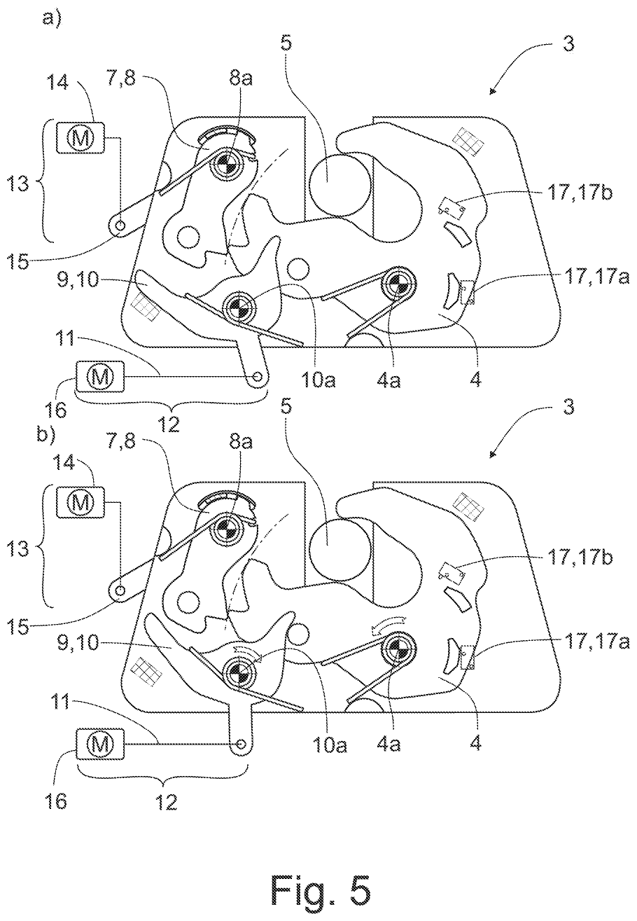

As already mentioned and as will be described with reference to the drawings, depending on the design of the motor vehicle lock arrangement 1, the lever-mechanism 9, which may include solely one single lever 10, can be actuated via the catch 4 (FIG. 2, 3) and/or the lever-mechanism 9 can be actuated via the pawl arm 8 (FIG. 4) and/or the lever-mechanism 9 can be actuated via an additional associated drive component 11 (FIG. 5, 6, 7), which drive component is part of a lever-mechanism drive train 12 configured to actuate the lever-mechanism 9. As can be seen in FIGS. 5 to 7, the catch 4 and the pawl 7 are not part of the lever-mechanism drive train 12.

The motor vehicle lock 3, as already explained above, is operable in a support operating condition (FIGS. 3 to 7) or in a normal operating condition (FIG. 2). If needed, the motor vehicle lock 3 automatically turns from the normal operating condition into the support operating condition, e.g. in case of high contamination, ice building or the like.

In some of the shown embodiments, the motor vehicle lock 3 is operable in a support operating condition in which, during at least a part of the closing sequence and/or during at least a part of the opening sequence, the lever-mechanism 9 is in a motion-coupled state with both the catch 4 and the pawl arm 8 simultaneously (FIG. 3a, 4a, 6a). Additionally or alternatively, the lever-mechanism 9 may be in a motion-coupled state with the catch 4 and not with the pawl arm 8 (immediately after the state in FIG. 3a until reaching the state in FIG. 3b; from primary closed state FIG. 3b and before reaching the state in FIG. 4a; in the state in FIG. 5b; FIG. 7a and before reaching the state in FIG. 7b). Additionally or alternatively, it is also conceivable that the lever-mechanism 9 is in a motion-coupled state with the pawl arm 8 and not with catch 4 (immediately before the state in FIG. 4b until reaching the state in FIG. 4b; immediately before the state in FIG. 7c until reaching the state in FIG. 7c). Additionally or alternatively, the lever-mechanism 9 may also be in a motion-coupled state with neither the catch 4 nor the pawl arm 8 (from open state through the state in FIG. 5a and before reaching the state in FIG. 5b; from open state and before reaching the state in FIG. 7a).

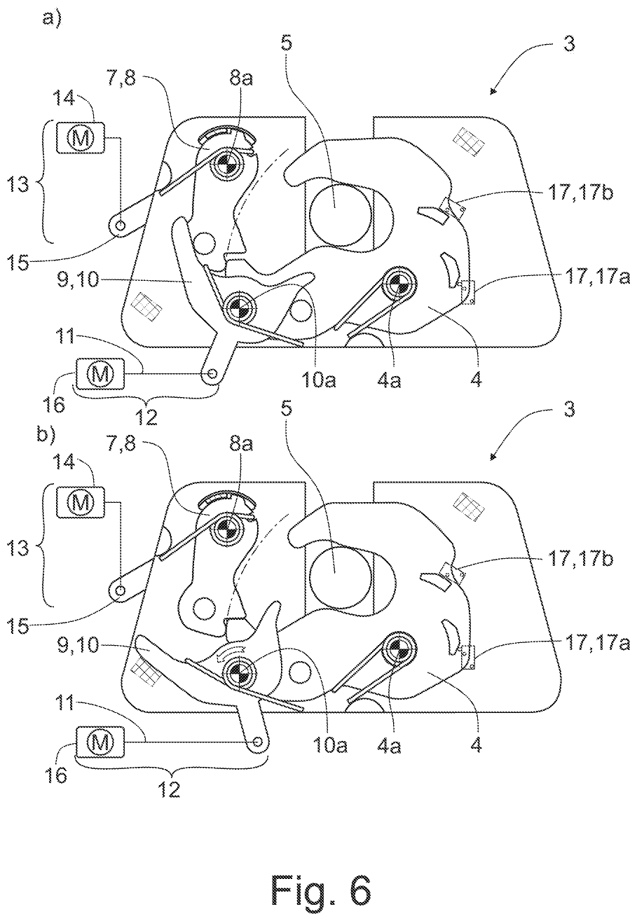

As can be seen in FIGS. 3a) and 6b), when the motor vehicle lock 3 is in the support operating condition, in the closed state of the motor vehicle lock 3, such as in the primary closed state of the motor vehicle lock 3, the lever-mechanism 9 is decoupled from at least one of the catch 4 and the pawl arm 8, which means that the lever-mechanism 9 is not in a motion-coupled state with at least one of the catch 4 and the pawl arm 8.

As can be seen in FIGS. 4b) and 5a), when the motor vehicle lock 3 is in the support operating condition, additionally or alternatively, in the open state of the motor vehicle lock 3 the lever-mechanism 9 may be decoupled from at least one of the catch 4 and the pawl arm 8, which means that the lever-mechanism 9 is not in a motion-coupled state with at least one of the catch 4 and the pawl arm 8.

According to the exemplary embodiments and as shown in FIG. 2, the motor vehicle lock 3 is also operable in a normal operating condition in which, during the entire closing sequence and/or during the entire opening sequence, the lever-mechanism 9 is never in a motion-coupled state with both the catch 4 and the pawl arm 8 simultaneously. As an example, during at least a part of the closing sequence and/or during at least a part of the opening sequence, the lever-mechanism 9 may be in a motion-coupled state with the catch 4 and not with the pawl arm 8 (from the state in FIG. 2b until reaching the primary closed state) or in a motion-coupled state with the pawl arm 8 and not with the catch 4 (not shown).

When the motor vehicle lock 3 is in the normal operating condition, in the closed state of the motor vehicle lock 3, such as in the primary closed state of the motor vehicle lock 3, the lever-mechanism 9 may be decoupled from at least one of the catch 4 and the pawl arm 8, which means that the lever-mechanism 9 is not in a motion-coupled state with at least one of the catch 4 and the pawl arm 8.

Additionally or alternatively, when the motor vehicle lock 3 is in the normal operating condition, also in the open state of the motor vehicle lock 3 the lever-mechanism 9 may be decoupled from at least one of the catch 4 and the pawl arm 8, which means that the lever-mechanism 9 is not in a motion-coupled state with at least one of the catch 4 and the pawl arm 8.

It is also conceivable that in an embodiment the lever-mechanism 9 can, in the normal operating condition and/or in the support operating condition, become decoupled from the catch 4 and/or the pawl arm 8 and can thereby, during at least a part of the closing sequence and/or during at least a part of the opening sequence, be actuated independently from the catch 4 and/or the pawl arm 8.

In the following the operation of the motor vehicle lock 3 during the closing sequence in the support operating condition of the motor vehicle lock 3 will be described in more detail.

According to FIGS. 3 and 5-7, when in the open position of the pawl arm 8 the lever-mechanism 9 is in a motion-coupled state with the pawl arm 8, during at least a part of the closing sequence the lever-mechanism 9 takes the pawl arm 8 with it in the direction from the open position to the closed position of the pawl arm 8. As an example, only during a part of the closing sequence the lever-mechanism 9 takes the pawl arm 8 with it in the direction from the open position to the closed position of the pawl arm 8.

According to FIG. 3a), when in the open position of the pawl arm 8 the lever-mechanism 9 is in a motion-coupled state with the pawl arm 8, during at least a part of the closing sequence the lever-mechanism 9 takes the pawl arm 8 with it into an intermediate position of the pawl arm 8, from which the pawl arm 8 moves further into its closed position without any force being transmitted from the lever-mechanism 9 to the pawl arm 8 in the direction of the closed position of the pawl arm 8, such as without there being any contact between the lever-mechanism 9 and the pawl arm 8 in the direction of the closed position of the pawl arm 8. As an example, during only a part of the closing sequence the lever-mechanism 9 takes the pawl arm 8 with it into an intermediate position of the pawl arm 8, from which the pawl arm 8 moves further into its closed position without any force being transmitted from the lever-mechanism 9 to the pawl arm 8 in the direction of the closed position of the pawl arm 8, such as without there being any contact between the lever-mechanism 9 and the pawl arm 8 in the direction of the closed position of the pawl arm 8.

An “intermediate position” of the pawl arm 8 means a position, which is between the open and the closed position of the pawl arm 8. When moving in the direction from the open position to the closed position of the pawl arm 8, the lever-mechanism 9 may be is in a motion-coupled state with the pawl arm 8 until the pawl arm 8 reaches the intermediate position. In the intermediate position the motion-coupling between the lever-mechanism 9 and the pawl arm 8 may be released.

As an example, the pawl arm 8 may be spring driven to move further into its closed position. “Spring driven” means that the pawl arm 8 is spring-loaded in the direction from its open position to its closed position.

According to FIGS. 6a) and 7c), when in the open position of the pawl arm 8 the lever-mechanism 9 is in a motion-coupled state with the pawl arm 8, during at least a part of the closing sequence the lever-mechanism 9 takes the pawl arm 8 with it into the closed position of the pawl arm 8. As an example, during only a part of the closing sequence the lever-mechanism 9 takes the pawl arm 8 with it into the closed position of the pawl arm 8. Accordingly, when moving in the direction from the open position to the closed position of the pawl arm 8, the lever-mechanism 9 is in a motion-coupled state with the pawl arm 8 until the pawl arm 8 reaches its closed position.

Moreover, as stated before, when the lever-mechanism 9 takes the pawl arm 8 with it in the direction from the open position to the closed position of the pawl arm 8, such as into the closed position of the pawl arm 8, the catch 4 may be in an overtravel position (FIG. 3a, 6a) or the catch 4 may be in a closed position, such as in its primary closed position (FIG. 7b, 7c).

It is also conceivable that, when the lever-mechanism 9 takes the pawl arm 8 with it in the direction from the open position to the closed position of the pawl arm 8, such as into the closed position of the pawl arm 8, the lever-mechanism 9 is in a motion-coupled state with the catch 4 and with no additional drive component configured for actuating the lever-mechanism 9 (FIG. 3a). Alternatively, the lever-mechanism 9 is in a motion-coupled state with the catch 4 and an additional drive component 11 configured for actuating the lever-mechanism 9 (FIG. 6a). Alternatively, the lever-mechanism 9 is in a motion-coupled state with an additional drive component 11 configured for actuating the lever-mechanism 9 and not with the catch 4 (FIG. 7b, 7c), which means that the lever-mechanism 9 is decoupled from the catch 4.

As an example, when the lever-mechanism 9 takes the pawl arm 8 with it in the direction from the open position to the closed position of the pawl arm 8, such as into the closed position of the pawl arm 8, the lever-mechanism 9 is actuated by the catch 4 (FIG. 3a) or by the additional drive component 11 configured for actuating the lever-mechanism 9 (FIG. 6a, 7c).

In the following the operation of the motor vehicle lock 3 during the opening sequence in the support operating condition of the motor vehicle lock 3 will be described in more detail.

According to FIG. 4, when the lever-mechanism 9 is in a motion-coupled state with the catch 4, the catch 4 being such as in the primary or secondary closed position or in a position between the closed, such as primary closed, position and the open position, during at least a part of the opening sequence the lever-mechanism 9 takes the catch 4 with it in the direction from the closed position to the open position of the catch 4. As an example, during only a part of the opening sequence the lever-mechanism 9 takes the catch 4 with it in the direction from the closed position to the open position of the catch 4.

It is also conceivable that, as is shown in FIG. 4a) and b), when the lever-mechanism 9 is in a motion-coupled state with the catch 4, the catch 4 being such as in the primary or secondary closed position or in a position between the closed, such as primary closed, position and the open position, during at least a part of the opening sequence the lever-mechanism 9 takes the catch 4 with it into an intermediate position of the catch 4, from which the catch 4 moves further into its open position without any force being transmitted from the lever-mechanism 9 to the catch 4 in the direction of the open position of the catch 4, and as on example, without there being any contact between the lever-mechanism 9 and the catch 4 in the direction of the open position of the catch 4. As an example, during only a part of the opening sequence, the lever-mechanism 9 takes the catch 4 with it into an intermediate position of the catch 4, from which the catch 4 moves further into its open position without any force being transmitted from the lever-mechanism 9 to the catch 4 in the direction of the open position of the catch 4, and as an example, without there being any contact between the lever-mechanism 9 and the catch 4 in the direction of the open position of the catch 4.

As one example, during at least a part of the opening sequence, such as during only a part of the opening sequence, the lever-mechanism 9 takes the catch 4 with it into an intermediate position of the catch 4 between its primary closed position and secondary closed position or into its secondary closed position (FIG. 4b)) or between its secondary closed position and opened position.

When moving in the direction from the closed position to the open position of the catch 4, the lever-mechanism 9 may be in a motion-coupled state with the catch 4 until the catch 4 reaches the intermediate position. In the intermediate position the motion-coupling between the lever-mechanism 9 and the catch 4 may be released.

As an example, the catch 4 may be spring drive to move the catch further into its open position. “Spring driven” means that the catch 4 is spring-loaded in the direction from its closed position to its open position.

Moreover, it is also conceivable that, when the lever-mechanism 9 takes the catch 4 with it in the direction from the closed position to the open position of the catch 4, the lever-mechanism 9 is in a motion-coupled state with the pawl arm 8 and with no additional drive component configured for actuating the lever-mechanism 9 (FIG. 4a). Alternatively, the lever-mechanism 9 is in a motion-coupled state with the pawl arm 8 and an additional drive component 11 configured for actuating the lever-mechanism 9 (not shown). Alternatively, the lever-mechanism 9 is in a motion-coupled state with an additional drive component 11 configured for actuating the lever-mechanism 9 and not with the pawl arm 8 (not shown), which means that the lever-mechanism 9 is decoupled from the pawl arm 8.

As an example, when the lever-mechanism 9 takes the catch 4 with it in the direction from the closed position to the open position of the catch 4, the lever-mechanism 9 is actuated by the pawl arm 8 (FIG. 4a) or by an additional drive component 11 configured for actuating the lever-mechanism 9 (not shown).

Moreover, in the exemplary embodiments shown in the drawings, the motor vehicle lock 3 may include a pawl arm drive train 13 configured to pivot the pawl arm 8 about its geometrical pawl axis 8a, preferably from its closed position into its open position. As an example, the pawl arm drive train 13 may include an electric motor 14 for pivoting the pawl arm 8. Alternatively, a manual actuation of the pawl arm drive train 13 is also conceivable. The pawl arm drive train 13 is designed separately from the lever-mechanism drive train 12 and interacts with the pawl arm 8 separately from the lever-mechanism 9.

As an example, the pawl arm drive train 13 may include an operating lever 15 acting on the pawl arm 8 such that the pawl arm 8 pivots about its geometrical pawl axis 8a, preferably from its closed position into its open position. In case of an electric motor 14, the electric motor 14 operates the operating lever 15, which in turn pivots the pawl arm 8.

As stated before, it is also conceivable that the motor vehicle lock 3 may include a lever-mechanism drive train 12 configured to actuate the lever-mechanism 9. Preferably, the lever-mechanism drive train 12 may include an electric motor 16 operating the drive component 11, which in turn actuates the lever-mechanism 9.

According to a preferred embodiment and as is shown in FIGS. 5 to 7, it is provided that the lever-mechanism drive train 12 comprising an electric motor 16 operating the drive component 11 is configured as a pulling aid for moving the catch 4 into its closed position, such as from its secondary closed position into its primary closed position.

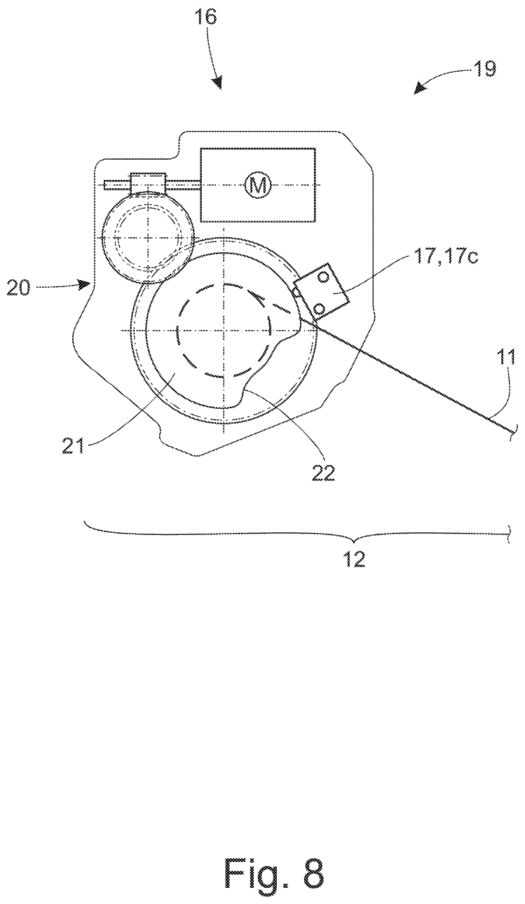

As an example, a switch or sensor arrangement 17 with at least one switch or sensor 17a, 17b, 17c and a control unit 18 electrically coupled with the switch or sensor arrangement 17 are provided. As schematically shown in FIGS. 5 to 7, for example, two switches or sensors 17a, 17b of the switch or sensor arrangement 17 determine specific positions of the catch 4, such as the switch or sensor 17a the secondary closed position and the switch or sensor 17b the primary closed position. As schematically shown in FIG. 8, a further switch or sensor 17c can also be associated to the lever-mechanism 9. This switch or sensor 17c makes it possible to distinguish different positions of the lever-mechanism 9, such as at least two positions. As an example, the switch or sensor 17c determines the initial position of the lever-mechanism 9, before being actuated. The switch or sensor 17c may be arranged inside a drive unit 19 of the lever-mechanism drive train 12, the drive unit 19 comprising the electric motor 16 and preferably a gearing 20.

The switch or sensor arrangement 17 is configured to generate a respective ON or OFF signal via the switches or sensors 17a, 17b, 17c, based on which the control unit 18 controls at least the electric motor 16 of the lever-mechanism drive train 12. Moreover, the electric motor 16 may operate a switching disc 21 with a switching contour 22 which interacts with the switch or sensor 17c (FIG. 8). For example, when the switch or sensor 17b generates a respective ON signal due to the catch 4 being in its primary closed position, the electric motor 16 is reversed until the lever-mechanism 9 is in the initial position as for example shown in FIG. 6b). Then, the switch or sensor 17c generates an ON signal indicating that the electric motor 16 can be shut off.

The pawl arm 8 may not need, and here does not have, a switch or sensor. This allows to save a switch or sensor in the motor vehicle lock 3, simplifies an electrical connector and the traces of the motor vehicle lock 3 and avoids the black spots.

As an example, the lever-mechanism 9, which may be actuated by the lever-mechanism drive train 12, may include or consist of one or more levers 10, preferably exactly one lever 10, the lever 10 or at least one of the levers 10 being pivotable about a geometrical lever axis 10a different from the geometrical catch axis 4a and/or from the geometrical pawl axis 8a, in particular distant from and parallel to the geometrical catch axis 4a and/or the geometrical pawl axis 8a. More preferably, the lever 10 or at least one of the levers 10 is or can be brought, such as via an associated lever arm, in a motion-coupled state with at least one of the catch 4, the pawl arm 8 and the drive component 11.

The respective lever or levers 10 may be spring-loaded. As an example, the lever 10 is spring-loaded in the same direction of rotation as the catch 4, when it is pivoted in the direction from its open position to its closed position, and/or in the same direction of rotation as the pawl arm 8, when it is pivoted in the direction from its open position to its closed position.

According to yet a further embodiment it is provided that in the closed state, such as in the primary closed state, of the motor vehicle lock 3 the lever-mechanism 9, such as at least one lever 10 of the lever-mechanism 9, overlaps with both the catch 4 and the pawl arm 8 in axial direction (FIG. 3b, FIG. 7). The “axial direction” is the extension direction of the geometrical catch axis 4a and/or extension direction of the geometrical pawl axis 8a. Such a construction provides a simple axial crash protection. Accordingly, a triple function of the lever-mechanism 9 is provided: The lever-mechanism 9 allows pivoting the pawl 7 and the catch 4 and provides a crash protection.

It is also conceivable that in the closed state, such as in the primary closed state, of the motor vehicle lock 3 the lever-mechanism 9, such as at least one lever 10 of the lever-mechanism 9, can move into a crash position due to inertia caused by a crash acceleration occurring in the event of a crash, in which crash position the lever-mechanism 9, such as at least one lever 10 of the lever-mechanism 9, blocks the pawl arm 8 in its closed position. Thereby, the lever-mechanism 9 provides a crash protection in a direction perpendicular to the extension direction of the geometrical catch axis 4a and/or extension direction of the geometrical pawl axis 8a.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A motor vehicle lock for use in a hatch leaf configured to change between a closed state and an open state, the motor vehicle lock comprising:
a catch configured to interact with a lock striker and pivotable about a geometrical catch axis;
a pawl having a pawl arm configured to interact with the catch and pivotable about a geometrical pawl axis different than the geometrical catch axis;
wherein when the motor vehicle lock is in the closed state,
the catch is in a catch-closed position to engage and hold the lock striker, and the pawl arm is in a pawl-arm-closed position, associated with the closed position of the catch, to engage and block the catch when the catch is in catch-closed position,
wherein when the motor vehicle lock is in the open state,
the pawl arm is in an pawl-arm-open position to release the catch and the catch is in an catch-open position to release the lock striker; and
a lever mechanism formed separately from the catch and the pawl arm, wherein
during a closing sequence to change the motor vehicle lock to the closed state and/or during an opening sequence to change the motor vehicle lock to the open state, the lever mechanism is coupled to the catch, to transmit movement between the lever mechanism and the catch, and the pawl arm to transmit movement between the lever mechanism and the pawl arm.

2. The motor vehicle lock arrangement of claim 1, wherein the motor vehicle lock is operable in a support operating condition so that during at least a portion of the closing sequence and/or during at least a portion of the opening sequence,
the lever mechanism is coupled to the catch and the pawl arm to simultaneously transmit movement from the lever mechanism to the catch and the pawl arm and/or,
the lever mechanism is coupled to the catch and not to the pawl arm to transmit movement from the lever mechanism to the catch and not the pawl and/or,
the lever mechanism is coupled to the pawl arm and not to the catch to transmit movement from the lever mechanism to the pawl and not the catch and/or,
the lever mechanism is neither coupled to the catch or the pawl arm so that the lever mechanism does not transmit to either the catch or the pawl.

3. The motor vehicle lock of claim 1, wherein the motor vehicle lock is operable in a normal operating condition, wherein when the motor vehicle lock operates in the normal operating condition and during the entire closing sequence and/or during the entire opening sequence, the lever mechanism is not coupled to either the catch or the pawl arm so that the lever arm does not simultaneously transmit movement from the lever mechanism to the catch and the pawl arm, and during at least a part of the closing sequence and/or during at least a part of the opening sequence, the lever mechanism is coupled to the catch and not coupled with the pawl arm, to transmit movement from the lever mechanism to the catch.

4. The motor vehicle lock of claim 1, wherein when the pawl arm is in the pawl-arm-open position, the lever mechanism is coupled to the pawl arm to transmit movement from the lever mechanism to the pawl arm and wherein during at least a portion of the closing sequence the lever mechanism and the pawl arm are coupled to one another and each move in a first direction as the pawl arm moves from the pawl-arm-open position to a pawl-arm-closed position.

5. The motor vehicle lock of claim 1, wherein when the pawl arm is in the pawl-arm-open position, the lever mechanism is coupled to the pawl arm to transmit movement from the lever mechanism to the pawl arm so that
during at least a portion of the closing sequence, the lever mechanism moves the pawl arm to a pawl-arm-intermediate position wherein the pawl arm is arranged to move from the intermediate position towards the pawl-arm-closed position.

6. The motor vehicle lock of claim 5, wherein, as the lever mechanism moves the pawl arm towards the pawl-arm-closed position, the catch moves towards the catch-closed position or the catch is in the catch closed position.

7. The motor vehicle lock of claim 4, wherein, as lever mechanism moves the pawl arm in the first direction, the lever mechanism is coupled to the catch to transmit movement from the lever mechanism to the catch.

8. The motor vehicle lock of claim 4, wherein, the catch is coupled to the lever mechanism to move the lever mechanism so that the pawl arm moves in the first direction and/or into the pawl-arm-closed position.

9. The motor vehicle lock of claim 8, wherein when the lever mechanism is coupled to the catch to move the catch, the catch is in a catch-primary-closed position or a catch-secondary-closed position or a position between the catch-primary closed position and the catch-open position.

10. The motor vehicle lock of claim 9, wherein, when lever mechanism is coupled to the catch to move the catch, the catch moves from either the catch-primary-closed position or the catch-secondary-closed position or the position between the catch-primary-closed position and the catch-open position to a catch-intermediate position, and wherein no force is transmitted from the lever mechanism to the catch as the catch moves from the catch-intermediate position to the catch-open position.

11. The motor vehicle lock of claim 9, wherein, as the lever mechanism moves the catch in a second direction from the catch-closed position to the catch-open position, the lever mechanism is coupled to the pawl arm to transmit movement between the pawl arm and the lever mechanism, no additional drive component moves the lever mechanism or the pawl arm.

12. The motor vehicle lock of claim 9, wherein as the lever mechanism moves the catch in a second direction from the catch-closed position to the catch-open position, the lever mechanism is coupled to the pawl arm, the lever mechanism is actuated by the pawl arm or the lever mechanism is actuated by an additional drive component.

13. The motor vehicle lock of claim 1, further comprising a pawl-arm drivetrain provided with an electric motor configured to pivot the pawl arm about the geometrical pawl axis from the pawl-arm-closed position to the pawl-arm-open position.

14. The motor vehicle lock of claim 1, further comprising a lever-mechanism drive-train provided with an electric motor and a drive component coupled to and configured to actuate the lever mechanism.

15. The motor vehicle lock of claim 1, wherein the lever mechanism is pivotable about a lever-arm-mechanism axis, wherein the lever-arm-mechanism axis is different than the geometrical catch axis.

16. The motor vehicle lock of claim 1, wherein when the motor vehicle lock is in the closed state, the lever mechanism overlaps, in an axial direction, the catch and the pawl arm.

17. The motor vehicle lock of claim 1, wherein when the motor vehicle lock is in the closed state, the lever mechanism is configured to move to a crash position in response to inertia caused by an acceleration during a crash event, so that the lever mechanism blocks the pawl arm in the pawl-arm-closed position.

18. The motor vehicle lock of claim 5, wherein during at least the portion of the closing sequence and as the pawl arm moves from the intermediate position towards the pawl-arm-closed position, the lever mechanism does not contact the pawl arm.

19. A motor vehicle lock for use in a motor vehicle, including a vehicle body and a hatch leaf coupled to the vehicle body, configured to change between a closed state and an open state, the motor vehicle lock comprising:
a catch configured to pivot about a catch axis between a catch-open position and a catch-closed position, wherein when motor vehicle lock is in the closed state, the catch is in the catch-closed position and engages a striker, disposed on the vehicle body or the hatch leaf, wherein when the motor vehicle lock is in the open state, the catch is disengaged from the striker;
a pawl arm configured to pivot about a pawl-arm axis between a pawl-arm-open position and a pawl-arm-closed position, wherein when motor vehicle lock is in the closed state, the pawl arm is in the pawl-arm closed position and the pawl arm engages and blocks the catch in the catch-closed position, wherein when the motor vehicle lock is in the open state, the pawl arm is in the pawl-arm-open position and releases the catch; and
a lever mechanism, wherein during a closing sequence to change the motor vehicle lock to the closed state, the lever mechanism is coupled to the catch, to transmit movement between the lever mechanism and the catch, and the pawl arm to transmit movement between the lever mechanism and the pawl arm.

20. A motor vehicle lock for use in a motor vehicle, including a vehicle body and a hatch leaf coupled to the vehicle body, configured to change between a closed state and an open state, the motor vehicle lock comprising:
a catch configured to pivot about a catch axis between a catch-open position and a catch-closed position, wherein when motor vehicle lock is in the closed state, the catch is in the catch-closed position and engages a striker, disposed on the vehicle body or the hatch leaf, wherein when the motor vehicle lock is in the open state, the catch is disengaged from the striker;
a pawl arm configured to pivot about a pawl-arm axis between a pawl-arm-open position and a pawl-arm-closed position, wherein when motor vehicle lock is in the closed state, the pawl arm is in the pawl-arm closed position and the pawl arm engages and blocks the catch in the catch-closed position, wherein when the motor vehicle lock is in the open state, the pawl arm is in the pawl-arm-open position and releases the catch; and
a lever mechanism, wherein during an opening sequence to change the motor vehicle lock to the open state, the lever mechanism is coupled to the catch, to transmit movement between the lever mechanism and the catch, and the pawl arm to transmit movement between the lever mechanism and the pawl arm.
